(19) United States
(12) Patent Application Publication
(10) Pub. No.: US 2024/0214045 A1
(43) Pub. Date: Jun. 27, 2024

(54) COMMUNICATION TERMINAL APPARATUS, COMMUNICATION SATELLITE APPARATUS, SATELLITE COMMUNICATION SYSTEM, AND NON-TRANSITORY STORAGE MEDIUM

(71) Applicant: NEC Corporation, Tokyo (JP)

(72) Inventors: Kazushi SUGYO, Tokyo (JP); Shingo WATANABE, Tokyo (JP); Kenji WAKAFUJI, Tokyo (JP); Masakazu ONO, Tokyo (JP)

(73) Assignee: NEC Corporation, Tokyo (JP)

(21) Appl. No.: 18/390,125

(22) Filed: Dec. 20, 2023

(30) Foreign Application Priority Data
Dec. 27, 2022 (JP) 2022-210706

(51) Int. Cl. H04B 7/06

(52) U.S. Cl. CPC H04B 7/0617

(57) ABSTRACT

To provide a communication terminal apparatus, a communication satellite apparatus, and a satellite communication system, capable of facilitating rapid determination of the direction of a beam. A communication terminal apparatus (10) is a communication terminal apparatus configured to communicate with a communication satellite apparatus (20) by means of a radio beam, the apparatus including: an antenna (11) configured to receive a plurality of beacons (Fa1 to Fa3) from at least one communication satellite apparatus, and to transmit and receive a directional radio beam; and at least one processor executing a control process of determining a plurality of candidate directions of the radio beam to be transmitted, on the basis of information included in the plurality of beacons.

### CROSS REFERENCE TO RELATED APPLICATIONS

This application is based upon and claims the benefit of priority from Japanese Patent Application No. 2022-210706 filed on Dec. 27, 2022, the disclosure of which is incorporated herein in its entirety by reference.

### TECHNICAL FIELD

The present invention relates to communication terminal apparatuses, communication satellite apparatuses, satellite communication systems, and non-transitory storage media.

### BACKGROUND ART

In some cases, communication between a communication terminal situated on the ground and a communication satellite located in space is carried out by means of radio waves. When the wavelength of a radio wave used is relatively short (e.g., millimeter wave), it is preferable that the communication terminal direct a beam (radio wave) against the communication satellite (e.g., see Patent Literature 1).

### CITATION LIST

### Patent Literature

[Patent Literature 1]

International Publication No. WO 2021/199218

### SUMMARY OF INVENTION

### Technical Problem

However, when the antenna is small for example, it is difficult to direct a beam (radio wave).

It is conceivable that the communication terminal may change the direction of a directional antenna to search for the communication satellite. However, search is time consuming and may fail. On the other hand, it is conceivable that the direction of the directional antenna of the communication terminal may be determined on the basis of the position information of the communication satellite transmitted therefrom. The position information is transmitted by means of a low frequency wave or a wide-directional beacon. The communication terminal can determine the direction of the beam in accordance with the position information of the communication terminal itself and the position information of the communication satellite transmitted from the communication satellite.

Here, obtaining position information of the communication terminal may be required due to movement or the like of the communication terminal. However, such obtaining may take, for example, 30 seconds to several minutes when the global positioning system (GPS) is used. This makes it difficult to achieve rapid communication between the communication terminal and the communication satellite. Furthermore, since communication satellites are moving, a period of time in which it is possible to communicate with communication terminal is not long. This may take time to obtain the position information, so that the period in which communication with the communication satellite is allowed may be shortened, or it may not be able to achieve the communication.

An example aspect of the present invention has been made in view of these problems, and an example object thereof is to provide a communication terminal apparatus, a communication satellite apparatus, and a satellite communication system each of which is capable of facilitating rapid determination of the direction of a beam.

### Solution to Problem

A communication terminal apparatus in accordance with an example aspect of the present invention is a communication terminal apparatus configured to communicate with a communication satellite apparatus by means of a radio beam, the apparatus including: an antenna configured to receive a plurality of beacons from at least one communication satellite apparatus, and to transmit and receive a directional radio beam; and at least one processor, the at least one processor executing a control process of determining a plurality of candidate directions of the radio beam to be transmitted from the antenna, on the basis of information included in the plurality of beacons.

### Advantageous Effects of Invention

According to an example aspect of the present invention, it is possible to provide a communication terminal apparatus, a communication satellite apparatus, a satellite communication system, and a non-transitory storage medium each of which is capable of rapid determination of the direction of a beam.

### BRIEF DESCRIPTION OF DRAWINGS

FIG. 1 is a block diagram illustrating a communication terminal apparatus in accordance with an example embodiment of the present invention.

FIG. 2 is a diagram illustrating a satellite communication system in accordance with an example embodiment of the present invention.

FIG. 3 is a block diagram illustrating a communication satellite apparatus in accordance with an example embodiment of the present invention.

FIG. 4 is a flowchart illustrating a communication method in accordance with an example embodiment of the present invention.

FIG. 5 is a diagram for describing derivation of communication allowed time.

FIG. 6 is a diagram for describing priorities of beamforming candidates.

FIG. 7 is a diagram illustrating direction determination using two communication satellite apparatuses.

FIG. 8 is a diagram illustrating direction determination using two communication satellite apparatuses.

FIG. 9 is a diagram illustrating direction determination using two communication satellite apparatuses.

FIG. 10 is a diagram illustrating direction determination using two communication satellite apparatuses.

FIG. 11 is a diagram illustrating directions to be determined.

### EXAMPLE EMBODIMENTS

### First Example Embodiment

The following description will discuss in detail a first example embodiment of the present invention with reference to the drawings. The present example embodiment is a basic form of example embodiments described later.

### (Configuration of Communication Terminal Apparatus)

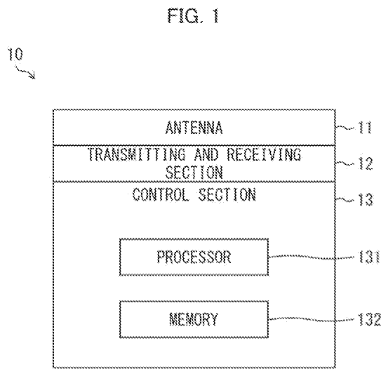

The following description will discuss the configuration of a communication terminal apparatus in accordance with the present example embodiment with reference to FIG. 1. FIG. 1 is a block diagram illustrating the configuration of a communication terminal apparatus 10. The communication terminal apparatus 10 in accordance with the first example embodiment includes an antenna 11, a transmitting and receiving section 12, and a control section 13.

The communication terminal apparatus 10 communicates with a communication satellite apparatus by means of radio beams. The antenna 11 is configured to receive a plurality of beacons from at least one communication satellite apparatus, and to transmit and receive directional radio beams. The antenna 11 is configured to switch between a directional mode for use in transmission and reception of the radio beams, and a nondirectional mode for use in transmission and reception of the beacons. Such switching may be carried out periodically. The antenna 11 may have a first antenna element for use in transmission and reception of the radio beams, and a second antenna element for use in transmission and reception of the beacons.

The plurality of beacons may be transmitted from each of a plurality of communication satellite apparatuses, or may be transmitted from a single communication satellite apparatus. For example, a single communication satellite apparatus may transmit a plurality of beacons while moving. The transmitting and receiving section 12 is configured to perform reception of the beacons, and transmission and reception of the beams, by using the antenna 11. The control section 13 is configured to control the transmission and reception of beacons and beams performed by the transmitting and receiving section 12.

The control section 13 determines a plurality of candidate directions of a radio beam to be transmitted from the antenna 11 on the basis of information included in the plurality of beacons, and then, in accordance with the determination, controls the transmitting and receiving section 12 to transmit the radio beam toward the communication satellite apparatus.

The control section 13 may include at least one processor 131 and at least one memory 132. The memory 132 stores a program P1 for causing the processor 131 to function as the control section 13. The processor 131 reads the program P1 from the memory 132 and executes the program P1, to realize the functions of the control section 13.

The processor 131 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory 132 may include, for example, a flash memory, a hard disk drive (HDD), a solid state drive (SSD), or a combination thereof.

As described in the foregoing, in the communication terminal apparatus 10 in accordance with the present first example embodiment, a plurality of candidate directions of a beam of a radio wave to be transmitted from the antenna 11 is determined on the basis of information included in the plurality of beacons. This facilitates determining the direction of the radio beam.

### Second Example Embodiment

The following description will discuss a second example embodiment of the present invention in detail with reference to the drawings. The same reference numerals are given to constituent elements which have functions identical to those described in the first example embodiment, and descriptions as to such constituent elements are omitted as appropriate.

### (Configuration of Satellite Communication System 1)

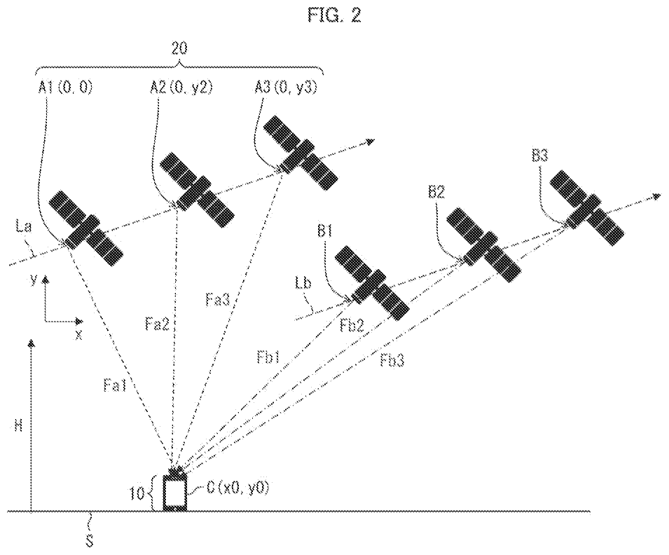

FIG. 2 is a diagram illustrating a satellite communication system 1 in accordance with an example embodiment of the present invention. The satellite communication system 1 includes a plurality of communication satellite apparatuses 20 (A1 to A3, B1 to B3) and the communication terminal apparatus 10 (C). The communication terminal apparatus C is located on a ground surface S, and the plurality of communication satellite apparatuses A1 to A3, B1 to B3 are located in space. The communication terminal apparatus C and the plurality of communication satellite apparatuses A1 to A3, B1 to B3 are capable of mutual communication. Herein, the communication terminal apparatus and the communication satellite apparatuses will be denoted by the reference symbols 10, 20 when the description thereof is concerned in the configuration, whereas they will be denoted by the reference symbols A1 to A3, B1 to B3, C when the description thereof is concerned in the location (coordinate). The right-and-left direction and the vertical direction of the sheet on which the drawing is shown are defined as the x-direction and the y-direction, respectively.

For example, each of the communication satellite apparatuses A1 to A3, B1 to B3 is a low-earth-orbit (LEO) satellite, which is in a relatively low orbit. Herein, to facilitate understanding, the communication satellite apparatuses A1 to A3 are located on line La, and the communication satellite apparatuses B1 to B3 are located on line Lb. As an example, the communication terminal apparatus C is located at coordinates (x0, y0) on ground S at an altitude of 0, and, as an example, the communication satellite apparatuses A1 to A3 are located at coordinates (0, 0), (0, y2), and (0, y3), respectively.

The communication satellite apparatuses A1 to A3 may be constituted by three communication satellite apparatuses 20 or a single communication satellite apparatus 20. That is, a single communication satellite apparatus 20 may move in the line (orbit) La, passing through the coordinates A1, A2, and A3. Similarly, the communication satellite apparatuses B1 to B3 may be constituted by three communication satellite apparatuses 20 or a single communication satellite apparatus 20.

Communication between the communication terminal apparatus 10 and each communication satellite apparatus 20 uses a directional radio beam (radio wave subjected to beamforming). Further, to support communication by means of a radio beam, radio beacons Fa1 to Fa3 and Fb1 to Fb3, each having no directivity, are transmitted from the communication satellite apparatuses (coordinates) A1 to A3 and B1 to B3, respectively. The communication terminal apparatus C determines a plurality of candidate directions of a radio beam to be transmitted on the basis of two or more beacons among the beacons Fa1 to Fa3 and Fb1 to Fb3 transmitted from the communication satellite apparatuses (coordinate) A1 to A3, B1 to B3, respectively.

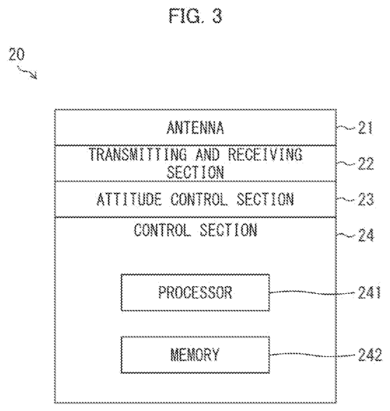

(Configuration of communication satellite apparatus 20) FIG. 3 is a block diagram illustrating an example of the configuration of each communication satellite apparatus 20 (A1 to A3, B1 to B3). Each communication satellite apparatus 20 includes an antenna 21, a transmitting and receiving section 22, an attitude control section 23, and a control section 24.

The antenna 21 is configured to transmit and receive nondirectional beacons and directional beams. The antenna 21 is configured to switch between a directional mode for use in transmission and reception of the radio beams, and a nondirectional mode for use in transmission and reception of the beacons. Such switching may be carried out periodically. The antenna 21 may have a first antenna element for use in transmission and reception of the radio beams, and a second antenna element for use in transmission and reception of the beacons.

Beacons Fa1 to Fa3 and Fb1 to Fb3 are transmitted by using a general-purpose or dedicated radio communication channel. It should be noted that information on this channel is shared by each communication satellite apparatus 20 and the communication terminal apparatus 10, and by the plurality of communication satellite apparatuses 20.

Each of the beacons Fa1 to Fa3 and Fb1 to Fb3 may include information on at least one communication satellite apparatus A1 to A3, B1 to B3, and more specifically, may include: satellite identification information (information for identifying the communication satellite apparatus 20); beacon identification information (information for identifying a plurality of beacons transmitted from the same communication satellite apparatus 20); the coordinates A1 to A3, B1 to B3 of the communication satellite apparatus 20; the movement speed (e.g., an absolute value of the movement speed, and the movement speed vector including the movement direction); the transmitted signal strength (beacon strength at transmission); and the sent time (the time at which the beacon is sent).

Each communication satellite apparatus 20 is capable of transmitting and receiving beacons to and from another communication satellite apparatus 20 (inter-satellite beacons), to share desired beacon information. That is, a beacon (beacon information) emitted from one communication satellite apparatus 20 to the communication terminal apparatus 10 is capable of including information on multiple communication satellite apparatuses 20 including not only information on the communication satellite apparatus 20 itself but also information on another communication satellite apparatus 20.

The transmitting and receiving section 22 is configured to perform reception of beacons, and transmission and reception of beams, by using the antenna 21. The attitude control section 23 is configured to adjust the attitude, movement, and the like of the communication satellite apparatus 20. The control section 24 is configured to control the transmission and reception of beacons and beams performed by the transmitting and receiving section 22, and the adjustment of the attitude and the like of the communication satellite apparatus 20 performed by the attitude control section 23.

The control section 24 may include at least one processor 241 and at least one memory 242. The memory 242 stores a program P2 for causing the processor 241 to function as the control section 24. The processor 241 reads the program P2 from the memory 242 and executes the program P2, to realize the functions of the control section 24. Similarly to the processor 131 and the memory 132 of the communication terminal apparatus 10, the processor 241 may include a CPU or the like, and the memory 242 may include a flash memory or the like.

The configuration of the communication terminal apparatus 10 in accordance with the second example embodiment can be depicted as in FIG. 1, similar to the first example embodiment, and the communication terminal apparatus 10 includes an antenna 11, a transmitting and receiving section 12, and a control section 13. The communication terminal apparatus 10 may include a timer for measuring time and a direction sensor for sensing the direction of the communication terminal apparatus 10. As described later, the control section 13 of the communication terminal apparatus 10 may calibrate the time of the timer on the basis of a beacon from a communication satellite apparatus 20. For example, the direction sensor may be a magnetic compass that senses the direction of the earth's magnetism (the direction to the north). The communication terminal apparatus 10 can determine the direction of a radio beam with reference to the direction sensor. Since the communication terminal apparatus 10 in accordance with the second example embodiment is substantially identical to the first example embodiment, other detailed description will be omitted.

### (Flow of Communication Method)

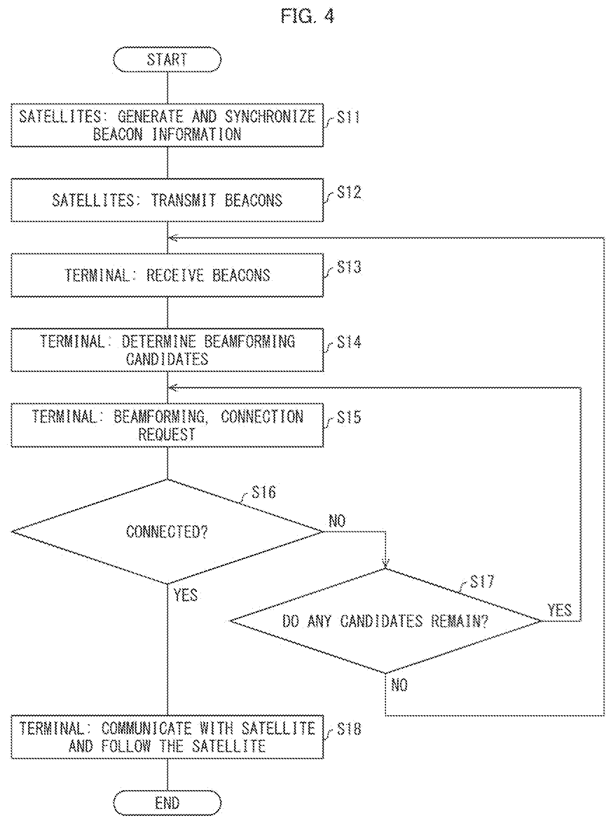

FIG. 4 is a flowchart illustrating a communication method in accordance with an example embodiment of the present invention. The flowchart illustrates the flow of processing carried out in the satellite communication system 1.

(1) Synchronization of Beacon Information between Communication Satellite Apparatuses 20 (step S11)

Information on each of the communication satellite apparatuses 20 is shared and synchronized between the communication satellite apparatuses 20. The antenna 21 of the communication satellite apparatus 20 transmits and receives beacons (inter-satellite beacons) from and to another communication satellite apparatus 20. The control section 24 obtains the coordinates and the movement speed of the another communication satellite apparatus 20 included in the inter-satellite beacon, and stores the coordinates and the movement speed in the memory 242. This enables the communication satellite apparatus 20 to transmit, to the communication terminal apparatus 10, a beacon including the coordinates and the movement speed of the another communication satellite apparatus 20.

Information as to the communication terminal apparatus 10 (e.g., a connection request sent from the communication terminal apparatus 10 to the another communication satellite apparatus 20, and a connection status of the another communication satellite apparatus 20 with the communication terminal apparatus 10) may be shared and synchronized between the communication satellite apparatuses 20. That is, the inter-satellite beacon transmitted and received between the communication satellite apparatuses 20 may include, as the information as to the communication terminal apparatus 10, the connection request sent from the communication terminal apparatus 10 to the another communication satellite apparatus 20, and the connection status of the another communication satellite apparatus 20 with the communication terminal apparatus 10, and the information as to the communication terminal apparatus 10 may be stored in the memory 242.

This allows a communication satellite apparatus 20, which has received, from the communication terminal apparatus 10, a radio beam including a connection request sent to another communication satellite apparatus 20, to communicate with the communication terminal apparatus 10 in place of the another communication satellite apparatus 20. In this case, the control section 24 of the communication satellite apparatus 20 determines whether or not to transmit a response radio beam in place of the another communication satellite apparatus 20 on the basis of the connection request sent to the another communication satellite apparatus 20 and the connection status of the another communication satellite apparatus 20 with the communication terminal apparatus 10. Further, for example, when another communication satellite apparatus 20 is disconnected from the communication terminal apparatus 10, the control section 24 of the communication satellite apparatus 20 can determine whether or not to continue connection with the communication terminal apparatus 10 in place of the another communication satellite apparatus 20 on the basis of the connection status of the another communication satellite apparatus 20 with the communication terminal apparatus 10.

### (2) Transmission of Beacon From at Least One Communication Satellite Apparatus 20 to Communication Terminal Apparatus 10 (Steps S12 and S13)

At least one communication satellite apparatus 20 transmits a plurality of beacons to the communication terminal apparatus 10, and the communication terminal apparatus 10 receives the plurality of beacons from the at least one communication satellite apparatus 20. For example, three communication satellite apparatuses 20 located at the respective coordinates A1 to A3 transmit beacons Fa1 to Fa3. As described above, a single communication satellite apparatus 20 may be employed, and the communication satellite apparatus 20 may move through the coordinates A1 to A3 and transmit the beacons Fa1 to Fa3. In either case, the communication terminal apparatus 10 can determine a plurality of candidate directions of a radio beam to be transmitted by using, for example, information on the coordinates A1, A2, and A3 included in the beacons Fa1 to Fa3. The number of beacons is not limited to 3, and may be 2 or 4, or more. As the number of beacons increases, the accuracy of the determined candidate directions improves.

The control section 13 of the communication terminal apparatus 10 obtains a receipt time of the beacon (time when the communication terminal apparatus 10 receives the beacon) and a received signal strength of the beacon (received signal level). It is preferable that the received signal strength of the beacon be subjected to error correction to eliminate errors (e.g., errors caused by Doppler, interference, rain, and the like in the physical layer).

At this time, the control section 13 of the communication terminal apparatus 10 can exclude an irrelevant beacon (e.g., a reflected or diffracted beacon after transmission). For example, for each beacon, the sent time at the communication satellite apparatus 20 (included in the beacon) may be compared with the receipt time of the beacon at the communication terminal apparatus 10, and a beacon or beacons each having a difference greater than a predetermined value are excluded. At this time, it is preferable that the time of the timer of the control section 13 have been calibrated (e.g., the time is synchronized with the timer of the communication satellite apparatus 20). As described later, the control section 13 of the communication terminal apparatus 10 may calibrate the time of the timer on the basis of a beacon from a communication satellite apparatus 20.

For example, the control section 13 of the communication terminal apparatus 10 may exclude an irrelevant beacon (e.g., beacons caused by cyber attacks (replay attack)), by using satellite identification information included in the beacon. For example, the control section 13 of the communication terminal apparatus 10 may exclude radio waves other than beacons, by using a radio wave map in which sources of transmission of radio waves are mapped. For example, use of the radio wave map can exclude radio waves from base stations for mobile phones situated on the ground.

(3) Determination of Beamforming Candidate by Communication Terminal Apparatus 10 (step S14)

The control section 13 of the communication terminal apparatus 10 determines a candidate range for beamforming (e.g., a plurality of candidate directions of a radio beam to be transmitted), on the basis of information included in the plurality of beacons transmitted from the at least one communication satellite apparatus 20 (e.g., information on the plurality of coordinates A1 to A3). Details thereof will be described later.

(4) Implementation of Beamforming (steps S15 to S17)

The control section 13 of the communication terminal apparatus 10 assigns priorities to the plurality of candidate directions and carries out beamforming. That is, the control section 13 of the communication terminal apparatus 10 selects a direction from among the plurality of candidate directions on the basis of the priorities, and transmits a radio beam including a connection request in the selected direction. The connection request may include the coordinates of the communication terminal apparatus 10 and the selected direction.

The antenna 21 of the communication satellite apparatus 20 receives the radio beam including the connection request emitted from the communication terminal apparatus 10. The control section 24 of the communication satellite apparatus 20 controls the transmitting and receiving section 22 to transmit a response radio beam in response to the radio beam including the connection request. For example, the control section 24 obtains the received signal strength of the radio beam including the connection request, and determines whether or not to transmit a response radio beam on the basis of the received signal strength. When it is determined to transmit a response radio beam, the control section 24 transmits the response radio beam. When it is determined not to transmit a response radio beam, the control section 24 transmits no response radio beam.

More specifically, the control section 24 can determine whether or not to transmit a response radio beam on the basis of a communication allowed time, which is determined on the basis of, for example, the received signal strength of the radio beam including the connection request. For example, when the communication allowed time is shorter than a predetermined value, the control section 24 determines not to transmit a response radio beam. In this case, the connection process between the communication satellite apparatus 20 and the communication terminal apparatus 10 is not continued. The communication allowed time is a time period in which communication between the communication terminal apparatus 10 and the communication satellite apparatus 20 is available. The communication allowed time is set because the communication satellite apparatus 20 moves at a high speed and the time period in which communication can be continuously established is relatively short (e.g., about one minute). For example, the communication allowed time may be derived from: the received signal strength (receipt level) of the radio beam including the connection request emitted from the communication terminal apparatus 10; the coordinates of the communication terminal apparatus 10 included in the connection request; the movement speed of the communication satellite apparatus 20; and the selected direction.

The derivation of the communication allowed time will be described in more detail below. Typically, the communication allowed time t can be defined by a time period t from when communication between the communication terminal apparatus 10 and the communication satellite apparatus 20 starts to when the distance to the communication terminal apparatus 10 reaches a communication limit distance R while the communication satellite apparatus 20 moves.

The communication limit distance R is a limit to the distance at which communication between the communication terminal apparatus 10 and the communication satellite apparatus 20 can established. At the communication limit distance R, the received signal strength of the radio beam emitted from the communication satellite apparatus 20 measured in the communication terminal apparatus 10 becomes the minimum receipt level. The communication limit distance R can be calculated on the basis of both (i) distance L0 between the communication terminal apparatus 10 and the communication satellite apparatus 20, and (ii) the radio beam received signal strength, at the time of reception of the radio beam including the connection request emitted from the communication terminal apparatus 10. It should be noted that in this calculation, it is considered that the strength of the radio wave attenuates in inverse proportion to the square of the distance.

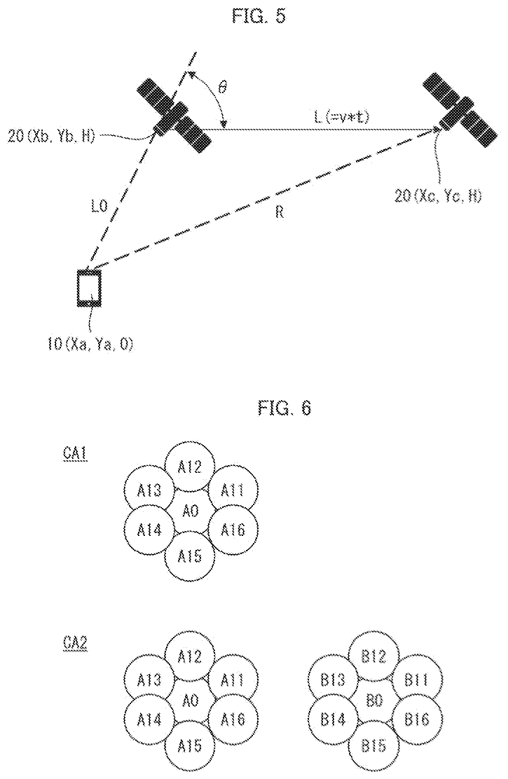

Here, for example, as illustrated in FIG. 5, it is assumed that the positions of the communication terminal apparatus 10 and the communication satellite apparatus 20 at the start of communication are defined as (Xa, Ya, 0) and (Xb, Yb, H), respectively, and the position of the communication satellite apparatus 20 when the communication satellite apparatus 20 moving by time t (communication allowed time) at speed v reaches the communication limit distance R is defined as (Xc, Yc, H). Herein, for facilitate understanding, it is assumed that the case where the altitude of the communication satellite apparatus 20 is constant.

Movement distance L of the communication satellite apparatus 20 can be calculated on the basis of the following equation (1) (cosine theorem).

$$cos ( 180 - θ ) = ( {α}^{2} + L 2 - R 2 ) / ( 2 * α * L ) \qquad Equation ( 1 )$$

$$α = {[ {( Xb - Xa )}^{2} + {( Yb - Ya )}^{2} ]}^{1 / 2}$$

θ: An angle formed by the moving direction of the communication satellite apparatus 20 with respect to the direction from the communication terminal apparatus 10 to the communication satellite apparatus 20.

The following equation (2) is derived therefrom.

$$cos ( 18 \; 0 - θ ) * 2 * α * L = {α}^{2} + {L}^{2} - {R}^{2} \qquad Equation ( 2 )$$

Furthermore, when A=cos(180−θ)*α, the following equation (3) is established.

$$2 * A * L - {L}^{2} = {α}^{2} - {R}^{2} \qquad Equation ( 3 )$$

$${A}^{2} - 2 * A * L + {L}^{2} = {( A - L )}^{2} = - {α}^{2} + {R}^{2} + {A}^{2}$$

Here, since L≥0 and A takes a negative value, the movement distance L is expressed by the following equation (4).

$$L = {( - {α}^{2} + {R}^{2} + {A}^{2} )}^{1 / 2} + A \qquad Equation ( 4 )$$

Then, the communication allowed time t is obtained from the movement speed v of the communication satellite apparatus 20 as in equation (5).

$$t = L / v \qquad Equation ( 5 )$$

As described above, the communication allowed time t may be derived from, for example: the received signal strength (receipt level) of the radio beam including the connection request emitted from the communication terminal apparatus 10; the coordinates (Xa, Ya, 0) of the communication terminal apparatus 10; and the movement speed v of the communication satellite apparatus 20.

As described above, the communication satellite apparatuses 20 can share the connection request sent from the communication terminal apparatus 10 to another communication satellite apparatus 20 and the connection status of the another communication satellite apparatuses 20 with the communication terminal apparatus 10, by using an inter-satellite beacon. Thus, when a communication satellite apparatus 20 receives, from the communication terminal apparatus 10, a radio beam including a connection request sent to another communication satellite apparatus 20, the control section 24 of the communication satellite apparatus 20 can determine whether or not to transmit, to the communication terminal apparatus 10, a response radio beam in place of the another communication satellite apparatus 20 on the basis of the connection request to the another communication satellite apparatus 20 and the connection status of the another communication satellite apparatus 20. When it is determined to transmit a response radio beam to the communication terminal apparatus 10 in place of the another communication satellite apparatus 20, the communication satellite apparatus 20 which has received the radio beam including the connection request sent to the another communication satellite apparatus 20 transmits the response radio beam to the communication terminal apparatus 10.

When receiving the response radio beam emitted from the communication satellite apparatus 20, the communication terminal apparatus 10 transmits a radio beam including a connection notification to the communication satellite apparatus 20, and the communication satellite apparatus 20 receives the connection notification, and thereby, the connection between the communication terminal apparatus 10 and the communication satellite apparatus 20 is established (steps S16 and S18).

The control section 24 of the communication satellite apparatus 20 determines that it is unable to connect with the communication terminal apparatus 10 when, for example, a state in which no connection is established with the communication terminal apparatus 10 continues for a predetermined duration of time after transmission of the response radio beam. In this case, the control section 24 deletes information on the communication terminal apparatus 10 from the memory 242 and resets the connection. The connection status between the communication satellite apparatus 20 and the communication terminal apparatus 10 is “Not Connected”.

The control section 13 of the communication terminal apparatus 10 determines whether or not a response radio beam has been received in response to the connection request of the radio beam transmitted in the selected direction. When it is determined that no response radio beam has been received, the control section 13 selects another direction from among the remaining candidate directions and transmits a radio beam including a connection request (steps S17 and S15). When it is determined that the response radio beam has been received, the control section 13 continues communication by means of the radio beam.

### (5) Communication Between Communication Terminal Apparatus 10 and Communication Satellite Apparatus 20 (Step S18)

After the connection between the communication satellite apparatus 20 and the communication terminal apparatus 10 is established, user data or the like is transmitted and received between the communication satellite apparatus 20 and the communication terminal apparatus 10. At this time, the control section 13 of the communication terminal apparatus 10 adjusts the direction of the radio beam (i.e., following of the moving communication satellite apparatus 20) on the basis of information included in the plurality of beacons from the at least one communication satellite apparatus 20 (e.g., the movement speed of the at least one communication satellite apparatus 20), so as to continue the communication with the communication satellite apparatus 20 by means of radio beam.

It should be noted that, in a short-term disconnection in communication, the control section 13 of the communication terminal apparatus 10 may attempt to resume communication by adjusting the direction of the radio beam on the basis of information on the plurality of communication satellite apparatuses 20 (e.g., the movement speed of the plurality of communication satellite apparatuses 20). For example, the control section 13 may simulate the movement of the communication satellite apparatus 20 and direct a beam in an assumed direction. However, when the connection is not resumed even when the radio beam has been transmitted for more than a predetermined duration, or for more than a predetermined number of times, the attempt of resuming connection may be stopped.

Even when the communication satellite apparatus 20 is in the connected state with the communication terminal apparatus 10, if the connecting period of time exceeds the connectable time (time in which the communication satellite apparatus 20 can be continuously connected to the communication terminal apparatus 10), the communication satellite apparatus 20 may be disconnected from the communication terminal apparatus 10. As described above, since the communication satellite apparatus 20 moves at a relatively high speed, the connectable time is limited. For example, the connectable time is determined on the basis of the coordinates and the movement speed of the communication satellite apparatus 20, and the coordinates of the communication terminal apparatus 10. Further, even when the communication satellite apparatuses 20 is in the connected state with the communication terminal apparatus 10, the communication satellite apparatus 20 may be disconnected from the communication terminal apparatus 10 when a state in which no communication of user data is established continues for a predetermined duration.

### (Details on Determining Beamforming Candidates)

Details of the determination of beamforming candidates will be described below.

As described above, the communication terminal apparatus 10 receives a plurality of beacons (e.g., 2 or 3 beacons) transmitted from one or more (e.g., 1, 2, or 3) communication satellite apparatuses 20 and determines a plurality of beamforming candidates (e.g., a direction in which the beam is directed) on the basis of information included in the plurality of beacons. Priorities are assigned to the plurality of beamforming candidates.

The priorities can be assigned on the basis of, for example, the arrangement of beamforming candidates. For example, as illustrated in CA1 in FIG. 6, it is assumed that the beamforming candidates are placed such that the candidate A0 is arranged at the center and the candidates A11 to A16 are arranged on the outer periphery of the candidate A0, when viewed from the communication terminal apparatus 10. In this case, priorities may be assigned to the candidates A0 and A11 to A16 in the order of decreasing precedence. This can be thought that the priorities are assigned in a manner such that the precedence decreases from the center to the outside. Here, as an example, priorities are assigned to the candidates A1 to A16 in a counterclockwise direction in the order of decreasing precedence. Alternatively, for example, priorities may be assigned to the candidates A16 to A11 in a clockwise direction in the order of decreasing precedence.

In a case where there are further candidates A21 to A2j (j: an integer of 2 or more) so as to surround the candidates A11 to A16, priorities may be assigned to the candidates A0, A11 to A16, and A21 to A2j outwardly from the center in a spiral manner in the order of decreasing precedence.

Here, consider a case where there are two sets of candidates, that is, A0, A11 to A16 (group A), and B0, and B11 to B16 (group B), as shown in CA2 in FIG. 6. In this instance, priorities may be assigned alternately in groups A and B, such as A0, B0, A11, B11, . . . , A16 and B16 in the order of decreasing precedence.

Alternatively, priorities may be assigned alternately to a plurality of candidates, such as A0, A11, B0, B11, A12, A13, B12, B13, . . . , A14, A15, B14, and B15 in the order of decreasing precedence. Here, it is alternated two by two, but may be alternated three or more by three or more. In this way, when it takes a certain amount of time to switch the beam direction of the communication terminal apparatus 10 between group A and group B, it is possible to improve the efficiency of processing.

As described above, it is possible to improve the efficiency of processing by assigning priorities to the plurality of beamforming candidates.

The plurality of beacons may include the coordinates and the movement speeds of the plurality of communication satellite apparatuses 20, and the transmitted signal strengths and the transmission times of the beacons. The communication terminal apparatus 10 can obtain information on the direction (orientation and inclination) of the communication terminal apparatus, and the received signal strengths and the receipt times of beacons.

Here, it is assumed that the communication terminal apparatus 10 may have some degree of error in terms of the coordinates of the communication terminal apparatus 10 itself and the receipt times of beacons. That is, the communication terminal apparatus 10 is movable (portable) and its coordinates are not fixed. The communication terminal device 10 may, for example, obtain its own precise coordinates from global positioning system (GPS) satellites. However, obtaining the coordinates requires some time (e.g., 30 seconds to several minutes). The required time hinders, for example, rapid communication with the communication satellite apparatuses 20. Further, since the clock of the communication terminal apparatus 10 is generally inaccurate, an error may occur in the receipt time of the beacon.

Here, the control section 13 of the communication terminal apparatus 10 calculates a distance from the communication satellite apparatuses 20 to the communication terminal apparatus 10, and further, a relative position (relative coordinate), on the basis of information included in the plurality of beacons, and then, the control section 13 estimates the direction (azimuth and elevation angle) of the communication satellite apparatuses 20 from the communication terminal apparatus 10. As will be described later, these calculations may be carried out using the Pythagorean theorem, Hero's formula, and the like.

(a) Calculation of Distance: Calculation of Distance D from Communication Terminal Apparatus 10 to Communication Satellite Apparatus 20

### (a1) Difficulty in Calculating Distance D

As shown below, it is difficult to accurately calculate distance D from the communication terminal apparatus 10 to a communication satellite apparatus 20.

Consider calculating distance D1 between the communication satellite apparatus C and the communication terminal apparatus (coordinates) A1. The distance D1 can, in principle, be calculated from the reaching time Δt of a beacon. The reaching time At of the beacon is a difference between sent time t01 of a beacon Fa1 from the communication satellite apparatus A1 and receipt time t02 of the beacon at the communication terminal apparatus C, that is, t (=t02−t01), and the distance D1 can be calculated as [t·C] (C: speed of light or a radio wave). However, as described above, the time of the timer of the communication terminal apparatus 10 is often not sufficiently accurate in calculating the distance D1.

On the other hand, the distance D may also be determined from power loss ΔP of the beacon. That is, the power loss ΔP is the difference ΔP (=P0−P1) between the transmission power P0 (dB value) of the beacon at transmission from the communication satellite apparatus A1 and the received power P1 (dB value) of the beacon at the time of receipt by the communication terminal apparatus 10. The distance D1 can be calculated as “ΔP/α” (α: a distance attenuation rate, or an attenuation rate of the beacon with respect to the unit distance). However, the calculation of the distance D1 based on the power loss ΔP generally has a greater error.

As described above, it is difficult to accurately calculate the distance D from the communication terminal apparatus 10 to the communication satellite apparatus 20. However, as described below, use of information about two or three communication satellite apparatuses (coordinates) A1 to A3 makes it possible to accurately calculate the distance D from the communication terminal apparatus 10 to the communication satellite apparatus 20. The following will describe it in order.

(a2) Calculation of Distance D with Use of Two Communication Satellite Apparatuses (coordinates) A1 and A

The following will describe a technique using two communication satellite apparatuses (coordinates) A1 and A2 to improve calculation accuracy of distances D1 and D2 between a communication terminal apparatus C and two coordinates A1 and A2, respectively. As described above, a single communication satellite apparatus may serve as the communication satellite apparatuses A1 and A2.

On the basis of difference Δt (=t1−t2) between the reaching times t1 and t2 of the two beacons, the control section 13 determines the difference (=D1−D2) between the distances D1 and D2, each of which is the distance from the corresponding one of the coordinates A1 and A2. Then, the control section 13 corrects the distances D1 and D2 on the basis of the attenuation due to the distances. The control section 13 may also calibrate the time of the timer on the basis of the attenuation due to the distances and synchronize it with the timer of the communication satellite apparatus 20. As described later, a plurality of candidate directions can be determined on the basis of the distances D1 and D2.

Details of the correction of the distances D1 and D2 will be described below.

The propagation loss of a radio wave in free space (free-space loss) S is expressed by the following equation (11).

$$S = {( 4 * π * r / λ )}^{2} \qquad Equation ( 11 )$$

λ: Wavelength of radio wave
r: Propagation distance of radio wave

Free-space loss Sdb, which is converted to dB, is expressed by the following equation (12).

$$Sdb = 20 * log ( 4 * π * r / λ ) \qquad Equation ( 12 )$$

It is assumed that beacons of the transmission power Ps1 and Ps2 transmitted from the communication satellite apparatuses A1 and A2 are received at the reception power Pr1 and Pr2 in the communication terminal apparatus 10. From the transmission powers Ps1 and Ps2, and the reception powers Pr1 and Pr2, the losses S1 and S2 of the radio waves transmitted from the coordinates A1 and A2, respectively, can be determined. In general, the ratio of these losses S1 and S2 should correspond to the difference between the distances D1 and D2. That is, the loss calculated by the equation (11) with use of the difference (=D1−D2) between the distances D1 and D2 as the distance r, and the ratio of the losses S1 and S2 should coincide.

However, as described above, since there is an error in each of the distances D1 and D2, the ratio of the losses S1 and S2 obtained based on the measured power does not correspond to the loss S calculated by the equation (12). Therefore, by determining the difference between the distances L1 and L2 such that the propagation loss S calculated on the basis of the equation (11) or (12) corresponds to the ratio of the losses S1 and S2, it is possible to correct the distances L1 and L2.

Note that the loss of radio wave is not limited to free-space loss, but may also be lost due to weather such as rainfall. Thus, it is preferable that the loss take into account not only the free-space loss but also the loss due to weather. Weather losses can be determined from actual measurements and empirical values.

The time of the timer may be calibrated on the basis of the corrected distances L1 and L2. For example, the time of the timer may be calibrated by the following equation (15).

$$t 1 = t 0 + L 1 / c \qquad Equation ( 15 )$$

t1: Time of the calibration timer
t0: Time when the communication satellite apparatus 20 transmits a beacon at the coordinate A1 (included in the information in the beacon)
c: Speed of light (beacon)

As described above, by considering the attenuation (loss) due to distance, it is possible to correct the distances D1 and D2, and further, it is possible to calibrate the timer of the communication terminal apparatus 10.

The foregoing can be summarized as follows. That is, the information included in the plurality of beacons (herein, beacons Fa1, Fa2) includes: a first coordinate A1 of at least one communication satellite apparatus 20; a first sent time of the first beacon Fa1 from the first coordinate A1; a second coordinate A2 of the at least one communication satellite apparatus 20; and a second sent time of the second beacon Fa2 from the second coordinate A2. The control section 13 obtains a first receipt time of the first beacon Fa1 and a second receipt time of the second beacon Fa2. The control section 13 then derives first distance D1 between the first coordinate A1 and the communication terminal apparatus C on the basis of the first sent time and the first receipt time, and also derives second distance D2 between the second coordinate A2 and the communication terminal apparatus C on the basis of the second sent time and the second receipt time. The control section 13 can determine a plurality of candidate directions on the basis of the first and second coordinates and the first and second distances D1 and D2.

The information included in the plurality of beacons includes a first transmitted signal strength of the first beacon Fa1 and a second transmitted signal strength of the second beacon Fa2. For example, the control section 13 obtains a first received signal strength of the first beacon Fa1 and a second received signal strength of the second beacon Fa2. The control section 13 can correct the first and second distances D1 and D2 on the basis of the first and second transmitted signal strengths and the first and second received signal strengths.

The information included in the plurality of beacons includes a first transmitted signal strength of the first beacon Fa1 and a second transmitted signal strength of the second beacon Fa2. The control section 13 obtains a first received signal strength of the first beacon Fa1 and a second received signal strength of the second beacon Fa2. The control section 13 calibrates the time of the timer on the basis of the first and second distances D1 and D2, the first and second transmitted signal strengths, and the first and second received signal strengths. The timer with the calibrated time can be used for obtaining the first receipt time and the second receipt time.

Here, when two communication satellite apparatuses A1 and A2 are used, it is assumed that the communication satellite apparatuses A1 and A2 move while adjusting the distance therebetween so as to be located at a relatively short distance. When the distance between the plurality of communication satellite apparatuses 20 is greater, the weather varies greatly depending on the communication satellite apparatuses 20, so that attenuation of the beacons Fa1 to Fa3 transmitted from each of the plurality of communication satellite apparatuses 20 greatly differ. This makes it difficult to perform accurate correction of the distances D1 and D2 and calibration of the time of the timer.

(a3) Calculation of Distance D by using Three Communication Satellite Apparatuses (Coordinates) A1 to A3

Next, a technique using three communication satellite apparatuses (coordinates) A1 to A3 to improve calculation accuracy of the distances D1 and D2 will be described. As described above, a single communication satellite apparatus may serve as the communication satellite apparatuses Al to A3. Also in this case, when three communication satellite apparatuses A1 to A3 are used, the communication satellite apparatuses A1 to A3 are moved while adjusting the distances therebetween so as to be located at relatively short distances.

Herein, as illustrated in FIG. 2, it is assumed that the three coordinates A1 to A3 and the communication terminal apparatus C are in the xy plane. For example, it is assumed that the communication satellite apparatuses A1 to A3 are located at coordinates A1(0, 0), A2(0, ya2), and A3 (0, ya3), respectively, and the communication terminal apparatus C is located at the coordinates C(x3, y3). However, the settings of the coordinates A1 to A3 and C are for facilitate understanding. Even if this settings are excluded, the following method can be established.

An error in distance due to a time lag of the timer of the communication terminal apparatus C is defined as α. The following equations (21) are derived (Pythagorean theorem).

$$D 1 = {( x {3}^{2} + y {3}^{2} )}^{1 / 2} + α \qquad ( 21 )$$

$$D 2 = {[ x {3}^{2} + {( ya 2 - y 3 )}^{2} ]}^{1 / 2} + α$$

$$D 3 = {[ x {3}^{2} + {( ya 3 - y 3 )}^{2} ]}^{1 / 2} + α$$

in which,
D1: a distance between the communication terminal apparatus C and the communication satellite apparatus A1,
D2: a distance between the communication terminal apparatus C and the communication satellite apparatus A2, and
D3: a distance between the communication terminal C and the communication satellite apparatus A3.

By the equations (21), x, y3, and a can be derived. That is, since there are three unknowns, x3, y3, and α, in the three equations, the unknowns x3, y3, and a can be derived by combining the three equations.

That is, use of the three coordinates A1 to A3 makes it possible to calculate the coordinates C(x3, y3) of the communication terminal apparatus 10 in which the error a of the distances D1 to D3 is canceled. Further, on the basis of the error a of the calculated distances, it is possible to calibrate the time of the timer of the communication terminal apparatus 10 and to synchronize the timer with that of the communication satellite apparatus 20.

(b) Calculation of Relative Position of Communication Satellite Apparatus 20 with Respect to Communication Terminal Apparatus 10

Hereunder, a technique for calculating the relative positions of the communication satellite apparatuses A1 and A2 with respect to the communication terminal apparatus C on the basis of the distances D1 and D2 will be described.

Herein, it is assumed that the coordinates A1 and A2, and the distances D1 and D2 of the coordinates A1 and A2 from the coordinate C are known, and the altitude of the communication terminal apparatus C is 0. For example, the coordinates A1 and A2 are set to (0, 0, H), (0, By, H), and the coordinate C is set to (x3, y3, 0).

The projection of the communication satellite apparatuses A1 and A2 onto the ground surface S (an altitude of 0) is defined as the coordinates A10 and A20, respectively. At this time, distance D00 between the coordinates A10 and A20, distance D10 between the coordinates A10 and C, and distance D20 between the coordinates A20 and C are calculated, to calculate the coordinates (x3, y3, 0) of the communication terminal apparatus C. This allows the control section 13 to determine, for example, first and second candidate directions corresponding to the first and second communication satellite apparatuses A1 and A2, respectively.

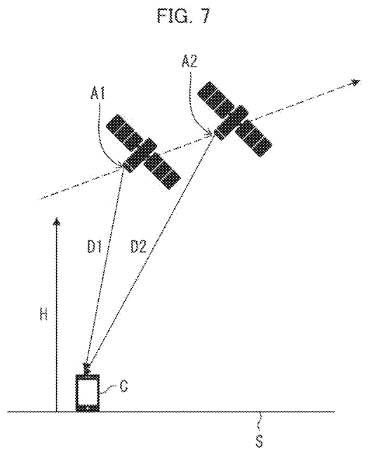

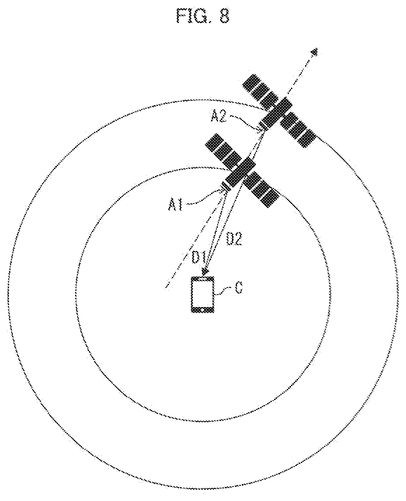

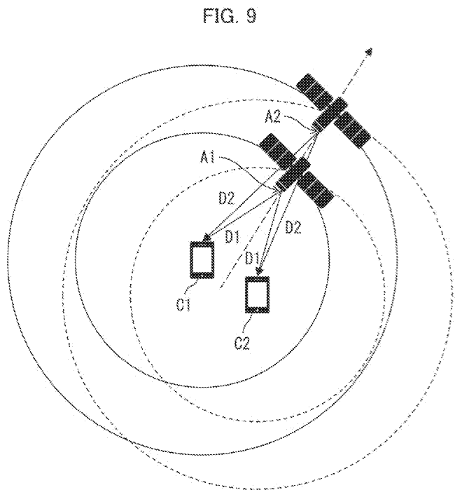

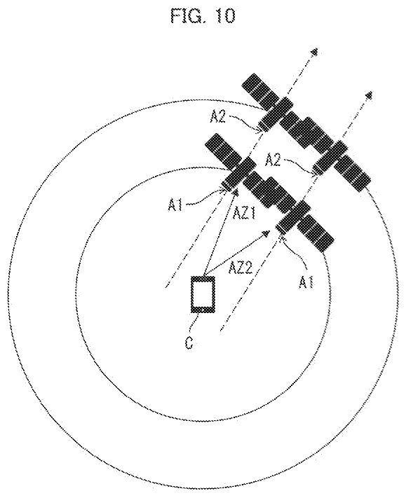

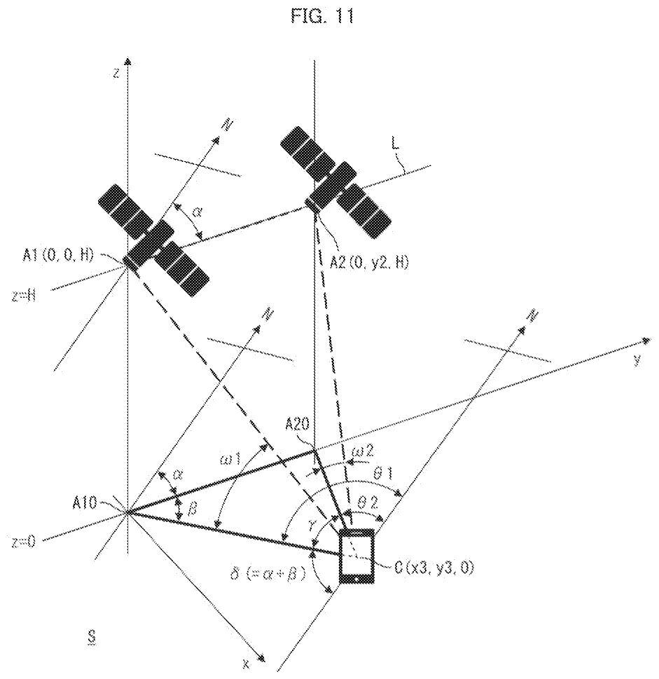

At this time, there are two candidates of the coordinates of the communication terminal apparatus C in the x direction. That is, as illustrated in FIGS. 7 and 8, when the coordinates A1 and A2, and the distances D1 and D2 from the coordinates A1 and A2 to the coordinates C are determined, the coordinate C on the ground surface S may be either C1 or C2 as illustrated in FIG. 9. When viewed from the communication terminal apparatus C, the direction may be either azimuth AZ1 or azimuth AZ2, as shown in FIG. 10. In this case, the control section 13 may determine a two candidate directions corresponding to the first coordinate on the basis of the first and second coordinates A1 and A2, and the first and second distances D1 and D2.

Here, since there is an error in each of the distance D1 and D2, there is a possibility of erroneous altitude of the communication terminal apparatus C, so that there may be an error in the coordinate of the communication terminal apparatus C to be calculated. The search range of beam alignment can be narrowed down in consideration of such error.

Hereunder, the coordinate of the communication terminal apparatus C is calculated on the basis of FIG. 11. Here, the coordinates of the communication satellite apparatuses A1 and A2 are set to (0, 0, H) and (0, y2, H), respectively, and the coordinate of the communication terminal apparatus C are set to (x3, y3, 0). The projections of the coordinates A1 and A2 to the ground surface S are defined as A10 (0, 0, 0) and A20 (0, y2, 0), respectively. At this time, the coordinate of the communication terminal apparatus 10 can be calculated by using the following equations (22).

That is, the area S1 of the triangle connecting the coordinates A10, A20, and C is obtained by the following equations (22) (Hero's formula).

$$S 1 = {[ {s}^{*} ( s - y 2 ) ( s - D 10 ) ( s - D 20 ) ]}^{1 / 2} \qquad ( 22 )$$

$$s = ( y 2 + D 10 + D 20 ) / 2$$

in which,
D10: a distance between the coordinates C and A10, and
D20: a distance between the coordinates C and A20.

The distances D10 and D20 are expressed by the following equations (23).

$$D 10 = {( D {1}^{2} - {H}^{2} )}^{1 / 2} \qquad ( 23 )$$

$$D 20 = {( D {2}^{2} - {H}^{2} )}^{1 / 2}$$

in which,
D1: a distance between the coordinates C and A1, and
D2: a distance between the coordinates C and A2.

Since the area S1 is expressed by the following equation (24), the equation (25) is satisfied.

$$S 1 = ( y 2 * x 3 ) / 2 \qquad ( 24 )$$

$$x 3 = 2 * S 1 / y 2 \qquad ( 25 )$$

Here, y3 can be calculated from x3.

$$y 3 = {[ D {10}^{2} - x {3}^{2} ]}^{1 / 2} \qquad ( 26 )$$

Here, when D20 satisfies the following condition (27), y3 is a negative value.

$$D 20 > {[ y {2}^{2} + x {3}^{2} ]}^{1 / 2} \qquad ( 27 )$$

As described above, if the coordinates A1 and A2 of the communication satellite apparatuses 20, and the distances D1 and D2 from the communication terminal apparatus 10 (coordinate C) to the coordinates A1 and A2, respectively, are known, the coordinate C of the communication terminal apparatus 10 can be calculated. Furthermore, the relative coordinates of the communication satellite apparatuses (coordinates) A1 and A2 with respect to the communication terminal apparatus 10 can be calculated from the coordinate C.

(c) Calculation of Direction from Communication Terminal Apparatus C to Communication Satellite Apparatuses A1 and A2

The azimuth and the elevation angle to the communication satellite apparatuses A1 and A2 from the coordinate of the communication terminal apparatus C can be calculated.

Angle θ1 from the communication terminal apparatus C to the communication satellite apparatus A1 can be expressed by the following equation (31).

$$θ 1 = 180 - ( α + β ) \qquad ( 31 )$$

α: Angle formed by a line passing through the coordinates A10 and A20 with respect to the north direction
β: Angle at the coordinate A10 of triangle TR, which is formed by the coordinates A10, A20, and C.

Here, since the lengths of three sides of the triangle TR are known, the angle β can be calculated from the second cosine theorem, to obtain the angle θ1.

$$cos ( β ) = ( y {2}^{2} + D {10}^{2} - D {20}^{2} ) / ( 2 * y 2 * D 10 ) \qquad ( 32 )$$

The angle to the communication satellite apparatus A2 can be calculated similarly.

Angle θ2 from the communication terminal apparatus C to the communication satellite apparatus A2 can be expressed by the following equation (33).

$$θ 2 = 180 - ( α + β ) - γ \qquad ( 33 )$$

γ: Angle at the coordinate C of triangle TR2, which is formed by the coordinates A10, A20, and C.

Since the lengths of the three sides of the triangle TR2 are known, the angle γ can be calculated from the second cosine theorem, to obtain the angle θ2.

Elevation angle ω1 to the communication satellite apparatus A1 is also obtained by the second cosine theorem.

$$cos ( ω 1 ) = ( D {10}^{2} + D {1}^{2} - {H}^{2} ) / ( 2 * D 10 * D 1 ) \qquad ( 34 )$$

Thus, the control section 13 of the communication terminal apparatus 10 can determine a candidate direction of a radio beam from information included in the plurality of beacons without using the GPS satellite. This facilitates rapid determination of the beam direction.

### Additional Remark 1

The present invention is not limited to the above example embodiments, but can be altered in various ways by a person skilled in the art within the scope of the claims. For example, the present invention also encompasses, in its technical scope, any example embodiment derived by appropriately combining technical means disclosed in the foregoing example embodiments.

### Additional Remark 2

Some or all of the above example embodiments can be described as below. Note however that the present invention is not limited to example aspects described below.

### (Supplementary Note 1)

A communication terminal apparatus (10) in accordance to Supplementary note 1 is a communication terminal apparatus configured to communicate with a communication satellite apparatus (20) by means of a radio beam, the apparatus including: an antenna (11) configured to receive a plurality of beacons from one or more communication satellite apparatuses, and to transmit and receive a directional radio beam; and a control section (13), the control section being configured to determine a plurality of candidate directions of the radio beam to be transmitted from the antenna, on the basis of information included in the plurality of beacons. With this configuration, it is possible to facilitate rapid determination of the direction of a beam by determining the plurality of candidate directions of the radio beam on the basis of the information included in the plurality of beacons.

### (Supplementary Note 2)

The communication terminal apparatus (10) in accordance with Supplementary note 2 employs, in addition to the configuration of Supplementary note 1, a configuration in which the control section: assigns priorities to the plurality of candidate directions; selects a direction from among the plurality of candidate directions on the basis of the priorities; and transmits a radio beam including a connection request in the selected direction. With this configuration, it is possible to facilitate rapid determination of the direction of a beam by selecting a direction from among the plurality of candidate directions on the basis of the priorities.

### (Supplementary Note 3)

The communication terminal apparatus (10) in accordance with Supplementary note 3 employs, in addition to the configuration of Supplementary note 2, a configuration in which the control section: determines whether or not a response radio beam has been received in response to the connection request of the radio beam transmitted in the selected direction; and when it is determined that no response radio beam has been received, selects another direction from among the remaining candidate directions and transmits a radio beam including a connection request, whereas, when it is determined that the response radio beam has been received, continues communication by means of the radio beam. With this configuration, it is possible to facilitate rapid connection with the communication satellite apparatus by determining whether or not a response radio beam has been received.

### (Supplementary Note 4)

The communication terminal apparatus (10) in accordance with Supplementary note 4 employs, in addition to the configuration of Supplementary note 3, a configuration in which the information includes a movement speed of the one or more communication satellite apparatuses, and the control section continues communication by means of the radio beam by adjusting a direction of the radio beam on the basis of the movement speed of the one or more communication satellite apparatuses. With this configuration, it is possible to facilitate maintaining connection with the communication satellite apparatus by adjusting the direction of the radio beam on the basis of the movement speed of the communication satellite apparatus.

### (Supplementary Note 5)

The communication terminal apparatus (10) in accordance with Supplementary note 5 employs, in addition to the configuration of any one of Supplementary notes 1 to 4, a configuration in which the information includes a first coordinate (A1) of the one or more communication satellite apparatuses, a first sent time of a first beacon from the first coordinate, a second coordinate (A2) of the one or more communication satellite apparatuses, and a second sent time of a second beacon from the second coordinate, and the control section: obtains a first receipt time of the first beacon, and a second receipt time of the second beacon; derives a first distance between the first coordinate and the communication terminal apparatus, on the basis of the first sent time and the first receipt time; derives a second distance between the second coordinate and the communication terminal apparatus, on the basis of the second sent time and the second receipt time; and determines the plurality of candidate directions on the basis of the first and second coordinates (A1, A2) and the first and second distances (D1, D2). With this configuration, it is possible to facilitate rapid connection with the communication satellite apparatus by determining the plurality of candidate directions on the basis of the first and second coordinates and the first and second distances.

(Supplementary Note 6)

The communication terminal apparatus (10) in accordance with Supplementary note 6 employs, in addition to the configuration of Supplementary note 5, a configuration in which the information includes a first transmitted signal strength of the first beacon and a second transmitted signal strength of the second beacon, and the control section: obtains a first received signal strength of the first beacon, and a second received signal strength of the second beacon; and corrects the first and second distances on the basis of the first and second transmitted signal strengths and the first and second received signal strengths. It is possible to facilitate more accurate determination of the candidate directions by correcting the distances to the first and second communication satellite apparatuses on the basis of the transmitted signal strengths and the received signal strengths of the first and second beacons.

### (Supplementary Note 7)

The communication terminal apparatus (10) in accordance with Supplementary note 7 employs, in addition to the configuration of Supplementary note 5, a configuration in which the information includes a first transmitted signal strength of the first beacon and a second transmitted signal strength of the second beacon, and the control section: obtains a first received signal strength of the first beacon, and a second received signal strength of the second beacon; and calibrates time of a timer on the basis of the first and second distances, the first and second transmitted signal strengths, and the first and second received signal strengths, the calibrated timer being for use in obtaining the first receipt time and the second receipt time. It is possible to facilitate more accurate determination of the candidate directions by calibrating the time of the timer on the basis of the transmitted signal strengths and the received signal strengths of the first and second beacons.

### (Supplementary Note 8)

The communication terminal apparatus (10) in accordance with Supplementary note 8 employs, in addition to the configuration of Supplementary note 5, a configuration in which the control section determines a first candidate direction corresponding to the first coordinate and a second candidate direction corresponding to the second coordinate. With this configuration, it is possible to accurately determine the first and second candidate directions corresponding to the first and second communication satellite apparatuses, respectively.

### (Supplementary Note 9)

A communication satellite apparatus (20) is a communication satellite apparatus configured to communicate with the communication terminal apparatus according to any one of Supplementary notes 1 to 8 by means of a radio beam, the communication satellite apparatus including: an antenna configured to receive a radio beam including a connection request from the communication terminal apparatus; and a control section, the control section being configured to cause a response radio beam to be transmitted in response to the radio beam including the connection request. With this configuration, it is possible to facilitate rapid connection with the communication terminal apparatus by causing the response radio beam to be transmitted in response to the radio beam including the connection request.

### (Supplementary Note 10)

A satellite communication system in accordance with Supplementary note 10 includes the communication terminal apparatus in accordance with any one of Supplementary notes 1 to 8 and the communication satellite apparatus in accordance with Supplementary note 9. With this configuration, it is possible to prove the satellite communication system capable of facilitating rapid connection between the communication terminal apparatus and the communication satellite apparatus.

### (Supplementary Note 11)

The communication terminal apparatus (10) in accordance with Supplementary note 11 employs, in addition to the configuration of Supplementary note 5, a configuration in which the control section determines two candidate directions corresponding to a first communication satellite apparatus on the basis of the first and second coordinates and the first and second distances. With this configuration, it is possible to determine the candidate directions addressing the uncertainty of the direction, on the basis of the first and second coordinates of the communication satellite apparatuses and the first and second distances of the communication satellite apparatuses.

### (Supplementary Note 12)

The communication satellite apparatus (20) in accordance with Supplementary note 12 employs, in addition to the configuration of Supplementary note 9, a configuration in which the control section: obtains a received signal strength of the radio beam including the connection request; determines whether or not to transmit the response radio beam on the basis of the received signal strength; and transmits the response radio beam when the response radio beam is determined to be transmitted. With this configuration, it is possible to facilitate communication ensuring connection time by determining whether or not to transmit a response radio beam on the basis of the received signal strength.

### (Supplementary Note 13)

The communication satellite apparatus (20) in accordance with Supplementary note 13 employs, in addition to the configuration of Supplementary note 9 or 12, a configuration in which the control section determines that it is unable to connect with the communication terminal apparatus when a state in which no connection is established with the communication terminal apparatus continues for a predetermined duration of time after transmission of the response radio beam. With this configuration, it is possible to facilitate effective use of resources by rapidly cancelling a state in which no connection is established with the communication terminal apparatus.

### (Supplementary Note 14)

The communication satellite apparatus (20) in accordance with Supplementary note 14 employs, in addition to the configuration of any one of Supplementary notes 9, 12, and 13, a configuration in which the antenna transmits and receives an inter-satellite beacon from and to another communication satellite apparatus, and the control section: obtains a coordinate and a movement speed of the another communication satellite apparatus, included in the inter-satellite beacon; and causes a beacon including the coordinate and the movement speed of the another communication satellite apparatus to be transmitted to the communication terminal apparatus. This makes it possible to transmit one beacon that includes information including information on another communication satellite apparatus, to attempt effective use of the information on communication satellite apparatuses.

### (Supplementary Note 15)

The communication satellite apparatus (20) in accordance with Supplementary note 15 employs, in addition to the configuration of Supplementary note 14, a configuration in which the inter-satellite beacon includes a connection request to the another communication satellite apparatus, and a connection status between the another communication satellite apparatus and the communication terminal apparatus, and when the communication satellite apparatus receives, from the communication terminal apparatus, a radio beam including the connection request to the another communication satellite apparatus, the control section determines whether or not to transmit the response radio beam in place of the another communication satellite apparatus on the basis of the connection request to the another communication satellite apparatus and the connection status. This makes it possible to facilitate connecting with the communication terminal apparatus in place of the another communication satellite apparatus, so that it is possible to facilitate effective use of the plurality of communication satellite apparatuses.

### (Supplementary Note 16)

A communication terminal apparatus (10) in accordance with Supplementary note 16 is a communication terminal apparatus configured to communicate with a communication satellite apparatus (20) by means of a radio beam, the apparatus including: an antenna (11) configured to receive a plurality of beacons from one or more communication satellite apparatuses, and to transmit and receive a directional radio beam; and a processor (13), the processor executing a control process of determining a plurality of candidate directions of the radio beam to be transmitted from the antenna, on the basis of information included in the plurality of beacons.

Note that the communication terminal apparatus (10) may further include a memory, which may store therein a program for causing the processor to carry out a process of determining a plurality of candidate directions of the radio beam. The program may be stored in a computer-readable, non-transitory, tangible storage medium.

### REFERENCE SIGNS LIST

1 Satellite communication system
10 Communication terminal apparatus
11 Antenna
12 Transmitting and receiving section
13 Control section
20 Communication satellite apparatus
21 Antenna
22 Transmitting and receiving section
23 Attitude control section
24 Control section

1. A communication terminal apparatus configured to communicate with a communication satellite apparatus by means of a radio beam, the apparatus comprising:
an antenna configured to receive a plurality of beacons from at least one communication satellite apparatus, and to transmit and receive a directional radio beam; and
at least one processor,
the at least one processor executing a control process of determining a plurality of candidate directions of the radio beam to be transmitted from the antenna, on the basis of information included in the plurality of beacons.

2. The communication terminal apparatus according to claim 1, wherein, in the control process, the at least one processor:
assigns priorities to the plurality of candidate directions;
selects a direction from among the plurality of candidate directions on the basis of the priorities; and
transmits a radio beam including a connection request in the selected direction.

3. The communication terminal apparatus according to claim 2, wherein, in the control process, the at least one processor:
determines whether or not a response radio beam has been received in response to the connection request of the radio beam transmitted in the selected direction; and
when it is determined that no response radio beam has been received, selects another direction from among the remaining candidate directions and transmits a radio beam including a connection request,
whereas, when it is determined that the response radio beam has been received, continues communication by means of the radio beam.

4. The communication terminal apparatus according to claim 3, wherein
the information includes a movement speed of the at least one communication satellite apparatus, and
in the control process, the at least one processor continues communication by means of the radio beam by adjusting a direction of the radio beam on the basis of the movement speed of the at least one communication satellite apparatus.

5. The communication terminal apparatus according to claim 1, wherein
the information includes a first coordinate of the at least one communication satellite apparatus, a first sent time of a first beacon from the first coordinate, a second coordinate of the at least one communication satellite apparatus, and a second sent time of a second beacon from the second coordinate, and
in the control process, the at least one processor:
obtains a first receipt time of the first beacon, and a second receipt time of the second beacon;
derives a first distance between the first coordinate and the communication terminal apparatus, on the basis of the first sent time and the first receipt time;
derives a second distance between the second coordinate and the communication terminal apparatus, on the basis of the second sent time and the second receipt time; and
determines the plurality of candidate directions on the basis of the first and second coordinates and the first and second distances.

6. The communication terminal apparatus according to claim 5, wherein
the information includes a first transmitted signal strength of the first beacon and a second transmitted signal strength of the second beacon, and
in the control process, the at least one processor:
obtains a first received signal strength of the first beacon, and a second received signal strength of the second beacon; and
corrects the first and second distances on the basis of the first and second transmitted signal strengths and the first and second received signal strengths.

7. The communication terminal apparatus according to claim 5, wherein
the information includes a first transmitted signal strength of the first beacon and a second transmitted signal strength of the second beacon, and
in the control process, the at least one processor:
obtains a first received signal strength of the first beacon, and a second received signal strength of the second beacon; and
calibrates time of a timer on the basis of the first and second distances, the first and second transmitted signal strengths, and the first and second received signal strengths,
the calibrated timer being for use in obtaining the first receipt time and the second receipt time.

8. The communication terminal apparatus according to claim 5, wherein, in the control process, the at least one processor determines a first candidate direction corresponding to the first coordinate and a second candidate direction corresponding to the second coordinate.

9. A communication satellite apparatus configured to communicate with the communication terminal apparatus according to claim 1 by means of a radio beam, the communication satellite apparatus comprising:
an antenna configured to receive a radio beam including a connection request from the communication terminal apparatus; and
at least one processor,
the at least one processor executing a control process in which a response radio beam is transmitted in response to the radio beam including the connection request.

10. A satellite communication system comprising the communication terminal apparatus according to claim 1 and a communication satellite apparatus configured to communicate with the communication terminal apparatus,
the communication satellite apparatus being configured to communicate with the communication terminal apparatus by means of a radio beam,
the communication satellite apparatus comprising:
an antenna configured to receive a radio beam including a connection request from the communication terminal apparatus; and
at least one processor,

10. the at least one processor executing a control process in which a response radio beam is transmitted in response to the radio beam including the connection request.

11. The communication terminal apparatus according to claim 5, wherein, in the control process, the at least one processor determines two candidate directions corresponding to a first communication satellite apparatus on the basis of the first and second coordinates and the first and second distances.

12. The communication satellite apparatus according to claim 9, wherein, in the control process, the at least one processor:
obtains a received signal strength of the radio beam including the connection request;
determines whether or not to transmit the response radio beam on the basis of the received signal strength; and
transmits the response radio beam when the response radio beam is determined to be transmitted.

13. The communication satellite apparatus according to claim 9, wherein, in the control process, the at least one processor determines that it is unable to connect with the communication terminal apparatus when a state in which no connection is established with the communication terminal apparatus continues for a predetermined duration of time after transmission of the response radio beam.

14. The communication satellite apparatus according to claim 9, wherein
the antenna transmits and receives an inter-satellite beacon from and to another communication satellite apparatus, and
in the control process, the at least one processor:
obtains a coordinate and a movement speed of the another communication satellite apparatus, included in the inter-satellite beacon; and
causes a beacon including the coordinate and the movement speed of the another communication satellite apparatus to be transmitted to the communication terminal apparatus.

15. The communication satellite apparatus according to claim 14, wherein
the inter-satellite beacon includes a connection request to the another communication satellite apparatus, and a connection status between the another communication satellite apparatus and the communication terminal apparatus, and
when the communication satellite apparatus receives, from the communication terminal apparatus, a radio beam including the connection request to the another communication satellite apparatus, the at least one processor determines, in the control process, whether or not to transmit the response radio beam in place of the another communication satellite apparatus on the basis of the connection request to the another communication satellite apparatus and the connection status.

16. A communication method of communicating with a communication satellite apparatus by using an antenna configured to transmit and receive a directional radio beam, the method comprising:
a process of receiving a plurality of beacons from at least one communication satellite apparatus by using the antenna; and
a process of determining a plurality of candidate directions of the radio beam to be transmitted from the antenna, on the basis of information included in the plurality of beacons.

17. A computer-readable, non-transitory storage medium storing therein a program for causing at least one processor to carry out:
a process of obtaining information included in a plurality of beacons from at least one communication satellite apparatus, received by an antenna configured to transmit and receive a directional radio beam; and
a process of determining a plurality of candidate directions of the radio beam to be transmitted from the antenna, on the basis of the information.
